(19) United States
(12) Patent Application Publication
(10) Pub. No.: US 2012/0257634 A1
(43) Pub. Date: Oct. 11, 2012

(54) SOFTWARE CONFIGURABLE NETWORK SWITCHING DEVICE

(75) Inventors: Joachim C. S. MARTILLO, Dorchester, MA (US); Frank T. SOLENSKY, Somerville, MA (US); Frank J. KASTENHOLZ, Chelmsford, MA (US); Dieter D. WEBER, South Lancaster, MA (US); Anthony Z. BONO, Sherborn, MA (US); Avri DORIA, Providence, RI (US)

(73) Assignees: Anthony Z. Bono, Sherborn, MA (US); Joachim C.S. Martillo, Cambridge, MA (US)

(21) Appl. No.: 13/368,316

(22) Filed: Feb. 7, 2012

Related U.S. Application Data
(63) Continuation of application No. 07/773,161, filed on Oct. 8, 1991, now abandoned.

(51) Int. Cl. H04L 12/56

(52) U.S. Cl. 370/401

(57) ABSTRACT

A network switching device comprises a plurality of input/output devices for receiving or sending communication packets, including an enabler to enable a user to selectively group the input/output devices into one or more logical bridges, and create MAC level bridging between the input/output devices grouped with each logical bridge. Another embodiment of the device includes an enabler to enable a user to selectively connect the bridges with one or more logical routers and perform network layer routing between the bridges associated with each logical router.

### CROSS-REFERENCE TO RELATED APPLICATIONS

This application is a continuation of co-pending U.S. application Ser. No. 07/773,161 filed Oct. 8, 1991, the entire disclosure of which is incorporated herein by specific reference thereto.

### FIELD OF THE INVENTION

The present invention relates to networking switching devices.

### BACKGROUND OF THE INVENTION

An increasingly important part of the computer revolution is connection of computers through computer networks. This allows computers to be used as tools for better communication between people and between databases, it allows individual computers to access more information, and it allows computers to share devices such as printers, fax machines, and modems. There are many types of computer networks and computer network protocols. Network protocols and the software which operates according to those protocols are normally divided into seven layers. As a general rule, the higher the software layer, the more specific and high level the software. Network switching can take place at several of these different software levels. Probably the two most common layers at which network switching take place are 1) the Media Access Control, or MAC, layer, which a sub-layer of the Data Link layer, and 2) the next higher layer than the Data Link layer, the Network layer.

There are multiple MAC layer protocols, such as Ethernet 2.0, Ethernet IEEE 802.3, and token ring IEEE 802.5. FIG. 1A shows the structure of an Ethernet 2.0 message packet 20. The packet starts with a six byte MAC destination address 22, followed by a six byte MAC source address 24, a two byte type field 26, a forty-six to fifteen hundred byte data field 28, and, finally, a four byte cyclical redundancy check, or CRC field 30. The destination field indicates the address number of the device on the network to which the packet is addressed. According to the Ethernet protocol, each Ethernet device in the world is supposed to be given a unique address number, so that when the device is connected to any Ethernet, its address will be unique. The source address is the address of the device sending the packet. The type field identifies the type of the particular Ethernet packet, indicating, for example, if the packet's data section 28 comprises a packet for use by a higher level switching protocol. The data field contains the actual data in the packet. When such a MAC packet is sent along a local area network which consists of only one segment, or branch, all the devices on the segment sense the packet, but only the device having the same address as that contained in the packet's destination field treats the message as being addressed to it. Thus, it is easy for multiple devices to be connected to one branch. But there is a limit to the number of devices that can communicate at a high rate on one branch of such a LAN. Also, there are limits to the length of a single network branch over which messages can be reliably passed. For these reasons it is often desirable to form a LAN by joining multiple separate branches with a network switching device.

A common type of device for network switching at the MAC layer is the so-called network bridge. A bridge is a well known type of network switching device to which multiple branches of a network are connected. When a packet is transmitted on a branch connected to a bridge, the bridge looks at the destination address in the packet. If the bridge knows the packet's destination address is associated with the branch from which the bridge received the packet, the bridge will not copy the packet to any other branch. If, however, the bridge knows the packet's destination address is associated with another specific branch connected to the bridge, it will copy the packet onto that specific branch, allowing the packet to be properly received. However, if the bridge does not know to which of its branches the destination address belongs, it will cause the packet to be sent on all of its branches except the one from which it received the packet, ensuring that if the packet is addressed to a destination on the network, that destination will get a chance to receive the packet.

One type of bridge which is commonly used is called a learning bridge. Learning bridges store in memory a list of the source addresses of the packets which they receive from each of the various branches which are directly connected to them. If a packet received from a given branch has a given source address, it indicates that the device with that address is connected, either directly or indirectly, to that particular branch. When the bridge receives a packet, it compares the destination address associated with that packet with the list of source addresses associated with each branch. If it finds the destination address in that list, it sends the packet to the branch associated with the destination address. If it does not find the address in the list, it sends the packet to all branches other than the one on which it was received.

Bridges also commonly use a spanning tree algorithm. This takes that part of the network which is directly connected to a given bridge and insures that it does not contain any loops. It does this by disconnecting those bridge ports, the connection of which would result in such loops. Preventing loops in a network comprised of bridges is important. If such loops existed, bridges could continuously cycle a given message around the loop, causing undesirable congestion.

A common bridging protocol which covers both learning bridges and a spanning algorithm is defined in the Draft P802.1d/D9 Mac Bridges specification prepared by IEEE Project 802, Local and Metropolitan Area Networks, July 1989.

Another type of network switching device is the router. As is well known in the networking arts, routers switch packets between branches of a network, like bridges, but they are different than bridges because they operate at the next higher level of network software, the so-called network layer, and because they provide more flexibility and control of the actual route which the packet takes through the network. Bridges normally switch packets based on the hard wired device addresses associated with the source and destination of each packet. As a result, the operation of the bridge is totally transparent from the viewpoint of a device on the network. Routers, on the other hand, switch packets based on Network layer addresses which can be assigned by users, and which in some network layer protocols are hierarchical. Thus, unlike bridge switching, which does not require any addressing other than that used on a single MAC layer network branch, router switching requires a different type of packet, with its own addressing information, from that used at the MAC layer. When a message is sent to a router over a MAC layer communications link, it requires a network layer packet of the type shown in FIG. 1B, so that it can be switched by the router, inside the data portion of a MAC layer packet of the type shown in FIG. 1A, so it can be transmitted on the MAC communications link.

There are many protocols which perform routing at the network layer. These include IP, ISO-IP, Novell Netware, Xerox XNS, DECNET Routing Layer, and Appletalk. The network layer also includes various protocols which are used in conjunction with the above protocols to provide information about the network layer network topology necessary for such routing to work properly.

Both bridges and routers have advantages. Bridges are often preferable for connecting smaller networks, because they are generally simpler and faster. However, they are not as good when network size grows. The fact that bridges switch based only numerical device addresses, rather than user-assigned addresses, tends to make addressing more complicated over a large network. Routers give users the ability to establish preferred paths between various networks, whereas bridges provide very little control over the paths that messages take. Bridges respond to messages the address of which they do not know by sending the message out over all of their branches other than that from which the message came. In large networks, where individual bridges are likely not to know the address of many individual devices, this can result in a highly congested system. Finally, because bridges switch at a lower level, they are more prone to relay improper messages and thus are less likely to protect a network from faulty transmission if a device goes haywire. Routers, on the other hand, tend to act as a fire wall beyond which the retransmission of such faulty messages is normally stopped.

For all of these reasons it can be seen that it is often desirable to configure a network as a combination of bridges and routers, using bridges to connect many local devices, but using routers to connect groupings of networks connected by bridges. In the past it has been possible to use routers to connect groups of bridged MAC networks, or subnets, but this has required using a MAC communication link between each such subnet and a MAC interface to the router. Such mechanical connection requires considerable time, space, and money.

### SUMMARY OF THE INVENTION

It is an object of the present invention to provide a network switching device which is less expensive than network switching devices in the prior art capable of performing the same function.

It is another object of the present invention to provide a network switching device which takes up less room than network switching devices in the prior art capable of performing the same function.

It is yet another object of the present invention to provide a network switching device which tends to reduce the amount of cabling required to connect a given group of devices to the network with the same level of bridging and routing.

It is still another object of the present invention to provide a network switching device which provides both ease and flexibility in connecting together networks by both bridging and routing.

The present invention relates to a network switching device. The switching device comprises a plurality of input/output devices for receiving or sending communications packets. It includes software means for enabling a user to selectively group the input/output devices into one or more logical bridges, and software means for performing MAC level bridging between the input/output devices grouped with each such logical bridge. In a preferred embodiment, the switching device further includes software means for enabling a user to selectively connect the bridges with one or more logical routers and software means for performing network layer routing between the bridges associated with each such logical router.

### DESCRIPTION OF THE DRAWINGS

These and other aspects of the present invention will become more evident upon reading the following description of the preferred embodiment in conjunction with the accompanying drawings, in which:

FIG. 1A is a diagram of the field structure of an Ethernet 2.0 message packet, FIG. 1B is a simplified diagram of the structure of a network layer protocol message packet, and together they show how the network layer protocol message packet can fit in the data field of the Ethernet packet;

FIGS. 2-7 are schematic diagrams showing various manners in which a device using present invention can connect the input/output devices connected into one or more bridges, one or more routers, or a combination of bridges and routers;

FIG. 8 is a pseudo-code representation of a routine for enabling a user to specify how he or she wishes to configure a device using the present invention;

FIGS. 9-11 are schematic hierarchical representations of the data structures in memory used to store configuration information entered by the user in the routine of FIG. 8, entered upon initialization by the routine of FIG. 12, or entered by operation of MAC layer or Network layer software;

FIG. 12 is a pseudo-code representation of a routine for initializing data structures used in a preferred embodiment of present invention; and

FIGS. 13-19 are pseudo-code representations of routines used in a preferred embodiment of the invention to bridge and/or route messages.

### DETAILED DESCRIPTION OF THE PREFERRED EMBODIMENT

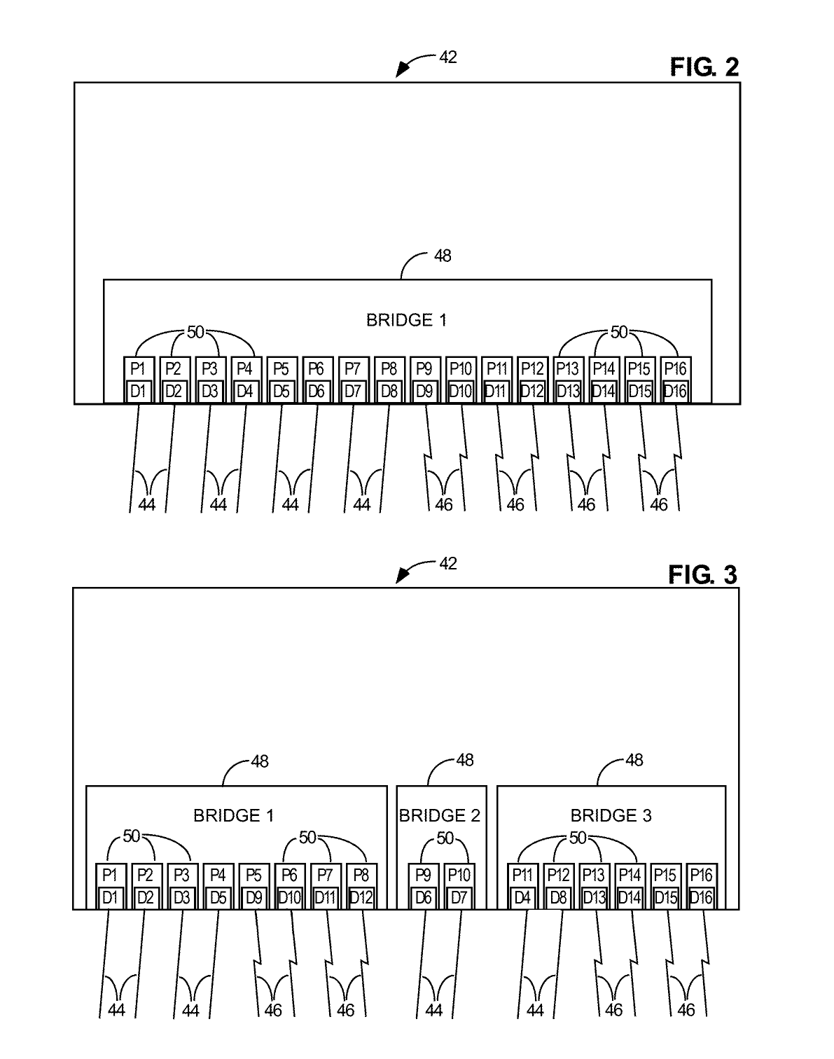

The present invention relates to a software configurable bridge/router. The preferred embodiment 42 of the invention is shown in FIGS. 2-7. This bridge/router can have up to sixteen input/output devices labeled D1 through D16. In the embodiment shown in these figures, devices D1-D8 are LAN devices such as Ethernet cards, which are connected to Ethernet networks 44. In other embodiments of the invention other known LAN devices could be used. In FIG. 2-7, the devices D9-D16 are WAN devices, which are normally longer distance WAN links 46, such as HDLC point-to-point links, which are normally made over leased phone lines. In other embodiments of the invention, other known WAN devices could be used. It should be understood, that the number of I/O devices used with the invention can be varied, and that the ratio of LAN to WAN devices can also be varied.

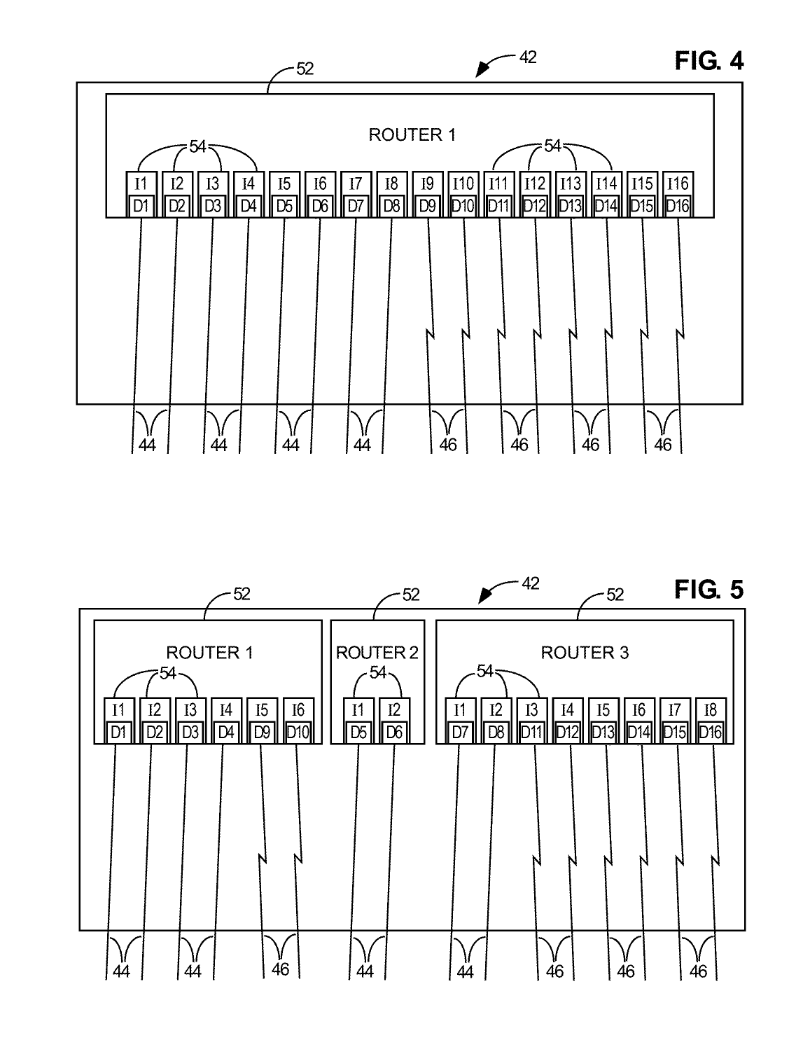

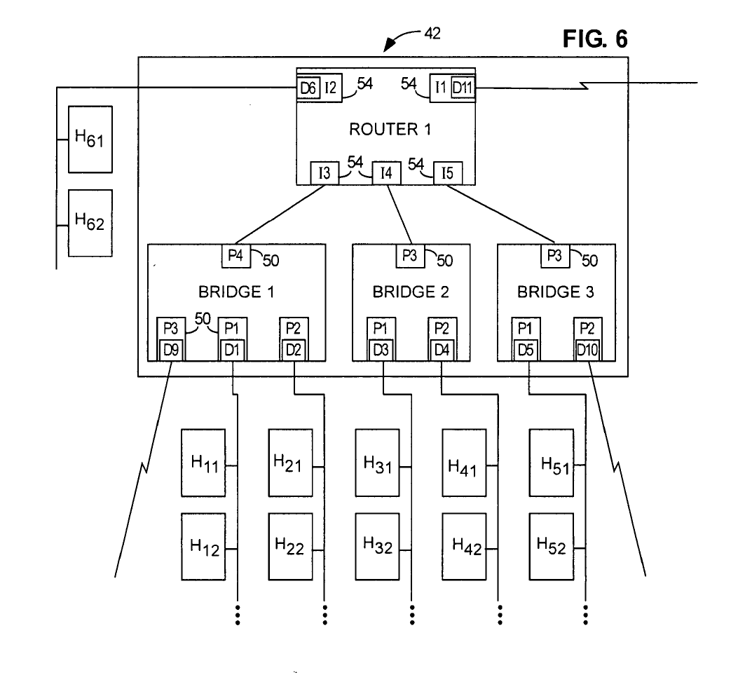

As is shown in FIG. 2, the current invention can be configured so that all the devices can be connected to one logical bridge 48, such as the bridge labeled Bridge 1 in that figure. It is also possible to map the I/O ports into multiple separate logical bridges 48, such as the Bridge 1, Bridge 2, and Bridge 3 shown in FIG. 3. If desired, all the I/O devices can be connected to one logical router 52, such as that labeled Router 1, in FIG. 4, or they can be connected into several separate logical routers 52, such as the logical routers labeled Router 1, Router 2, and Router 3 in FIG. 5. FIG. 6 shows it is possible for some individual I/O devices to be connected to directly to a logical bridge and some to be connected directly to a router. In FIG. 6, three I/O devices, two LAN and one WAN, are connected to logical Bridge 1, two to logical Bridge 2, both LAN, two to logical Bridge 3, one LAN and one WAN, and two are connected to logical Router 1, one LAN and one WAN. As is also shown in FIG. 6, it is possible for a logical bridge to be connected to a logical router. Each connection to a logical bridge is called a port 50 of that bridge. Each connection to a logical router is called an interface 54 of that router. As can be seen from FIG. 6, a port of a logical bridge can be connected either to an I/O device or to a logical router. Correspondingly, an interface 54 of a logical router can be connected either to an I/O device or to a logical bridge. Since FIG. 6 will be used later in explaining the software routines used with the preferred embodiment, its LANs are shown with host devices H61 and H62 hung off them. Although these devices are labeled with an “H” for “host”, they could be other types of computing devices, such as printer and file servers.

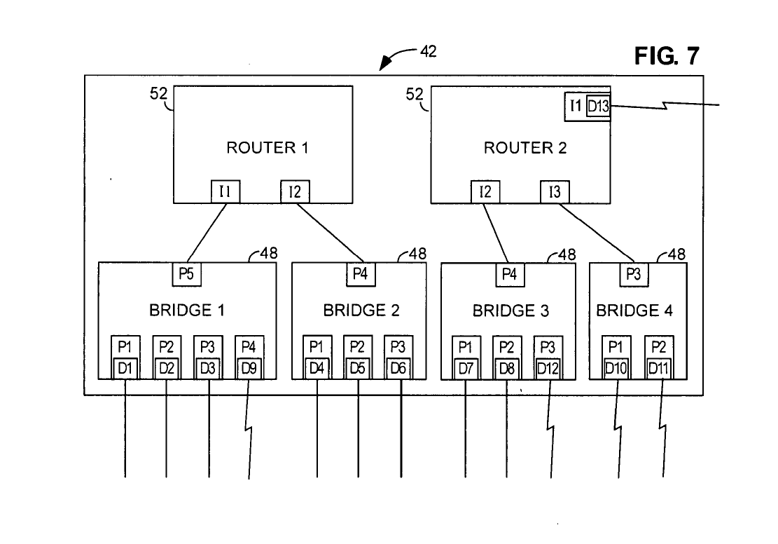

Finally, FIG. 7 shows that the preferred embodiment of the invention can be configured to have both multiple logical bridges 48 and multiple logical routers 52. This enables the preferred invention to be configured into two entirely separate networks, each using bridging and routing.

The preferred embodiment of the invention is a computer system having a programmable CPU and the memory necessary to run the software capable of configuring the bridge/router and to operate it once configured. In the preferred embodiment, the CPU and memory are located on a printed circuit mother board. This mother board is designed so that additional printed circuit cards containing I/O devices can be plugged into it. The mother board contains an RS232 port capable of driving a standard terminal, enabling the system to project information about the system's current status and configuration on the screen of the terminal, and allowing the user to enter information to change and control the system on the keyboard of the terminal. In another embodiment, the programmable CPU, memory, multiple I/O devices, and RS232 port are all placed on one printed circuit board designed to fit into a standard bus computer. Those skilled in the art of computer design will understand that any combination of one or more programmable devices and memory, with more than one I/O device, could be used to create equivalent functionality.

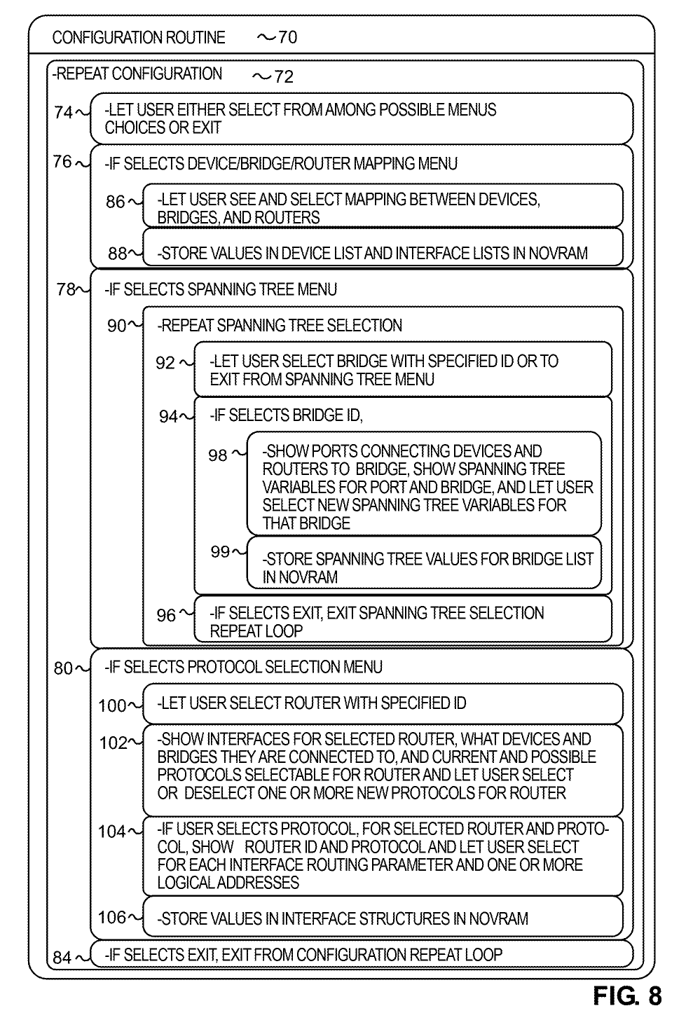

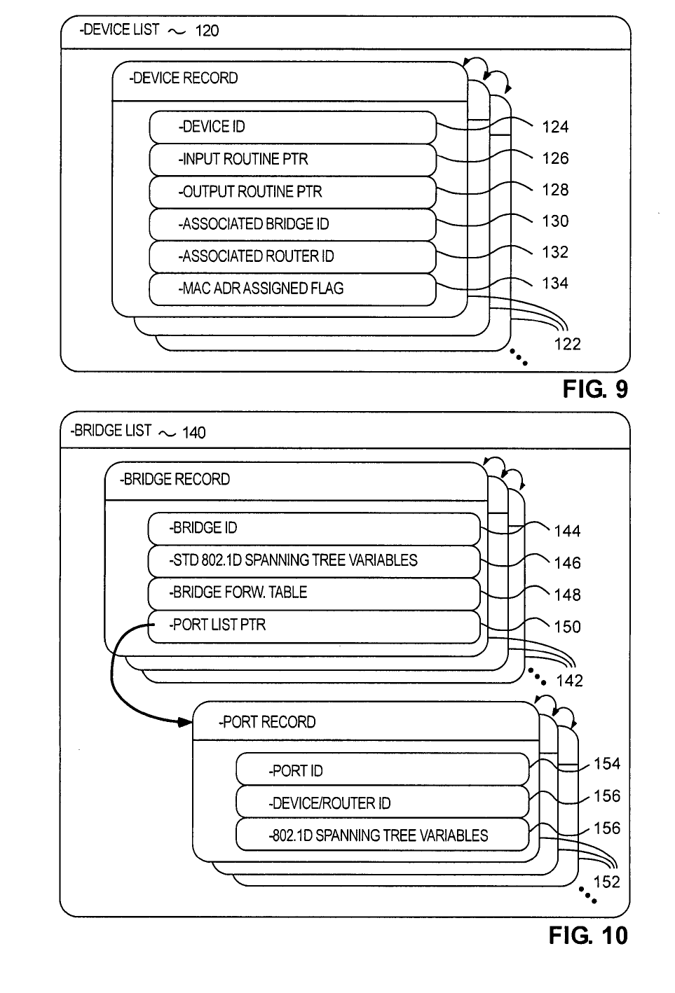

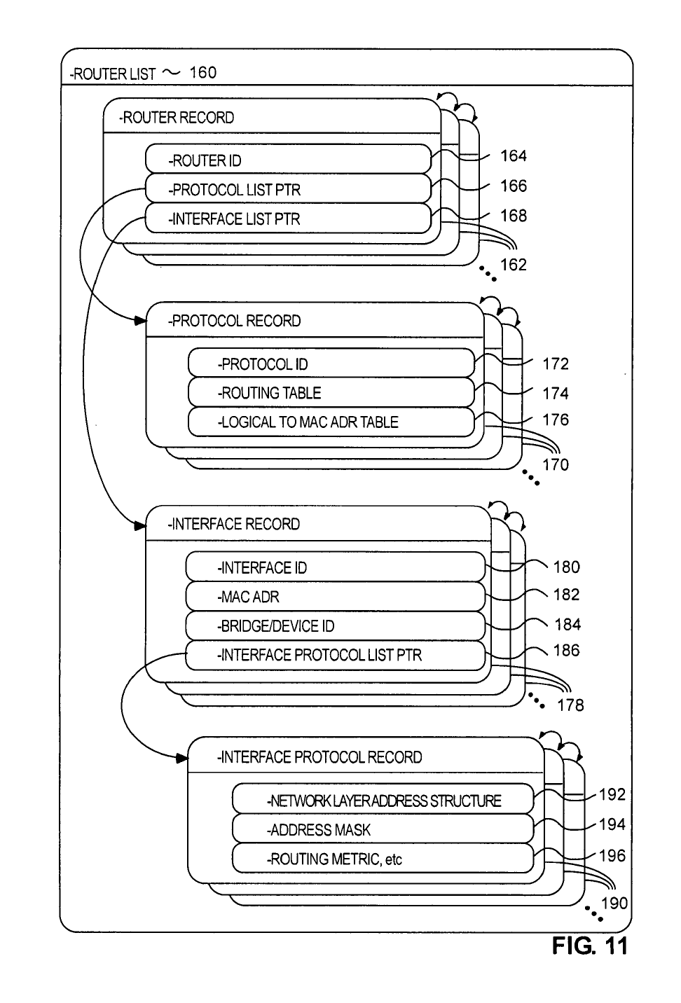

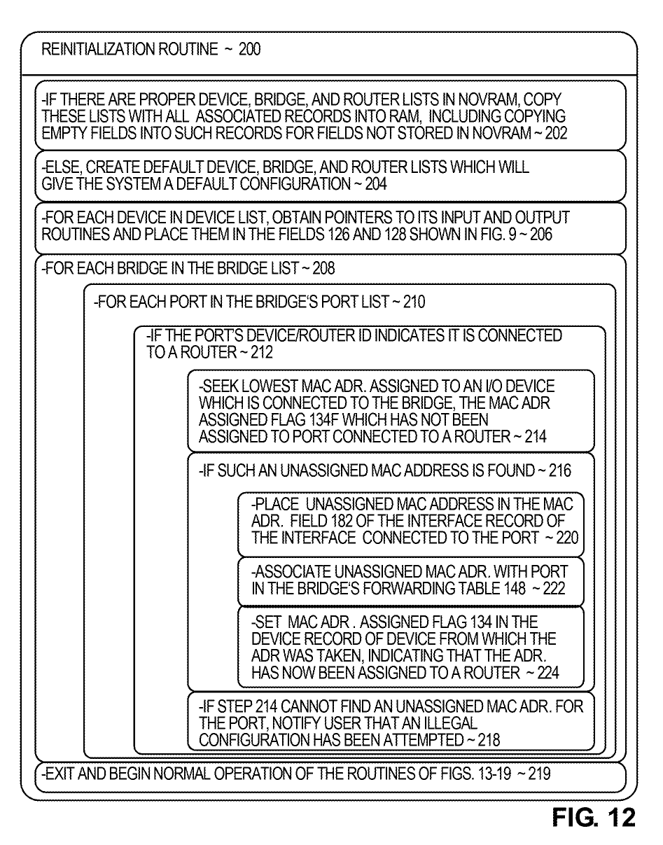

FIGS. 8 and 12 describe two software routines which enable a user to configure the bridge/router 42 as desired. These routines are used to create and fill the fields of the data structures shown in FIGS. 9-11, which are created in RAM. As is explained below, these data structures control the current configuration of the bridge/router. The configuration routine described in FIG. 8 allows the user to select all of the user-selectable configuration values contained in the data structures of FIGS. 9-11. It also causes those user-selected values to be stored in non-volatile memory, or NOVRAM. It stores them in NOVRAM because NOVRAM does not loose data when power is turned off. The user-selected values are stored in data structures which are virtually identical to those shown in FIGS. 9-11, except that, in order to save space in NOVRAM, they only contain data fields relating to user-selected configuration values. Once the user has entered these values with the configuration routine, he or she can then reset the system, which causes the initialization routine of FIG. 12 to be performed. The routine of FIG. 12 creates the data structures of FIGS. 9-11 in RAM, copies configuration data from NOVRAM into them, and then fills out or update the other fields of those data structures. Once this is done, the bridge/router will be prepared to operate as configured by the user in the routine of FIG. 8.

In the preferred embodiment, the mapping between devices, bridges, and routers is only changed upon initialization, to avoid certain complexities which can arise from changing the network topology while the network is running. In embodiments designed to deal with such complexities, such mapping changes could be made while the network is running.

The RAM data structures of FIGS. 9, 10, and 11 contain a device list 120, a bridge list 140, and a router list 160, respectively. The devices list 120, shown in FIG. 9, contains a separate device record 122 for each I/O device connected to the system stored in NOVRAM. Each device record includes a device ID 124, an input routine pointer 126, an output pointer 128, an associated bridge ID 130, an associated router ID 132, and a MAC address assigned flag 134. The device ID uniquely identifies the device associated with the given device record. As is explained below with regard to FIG. 14, the input routine pointer is a pointer to the routine which is called by the CPU to see if the device has received a message, and if so, to process it. The output routine pointer is a pointer to a routine called by the CPU when it wants the device to output a message. The associated bridge ID indicates the ID of the bridge, if any, to which the device is connected. The associated router ID indicates the router, if any, to which the device is connected. Finally, the MAC address assigned flag indicates if the devices address has been assigned by a bridge to a router, as is described below in discussion of the initialization routine.

A device list similar to that shown in FIG. 9 is stored in NOVRAM, the only difference being that the device records stored in NOVRAM do not contain fields corresponding to the input and output routine pointers, 126 and 128, respectively, and the MAC address assigned flag 134, since these variables are given values during initialization.

The bridge list 140, shown in FIG. 10, includes a separate bridge record 142 for each logical bridge in the current configuration. Each such bridge record includes the following fields: a bridge ID to identify the given bridge associated with the record; a field containing a plurality of standard spanning tree variables used in conjunction with the bridging protocol being used, which is the 802.1D protocol in the preferred embodiment; a bridge forwarding table, which is a table mapping MAC addresses to port IDs; and a port list pointer, which is a pointer to a list of port records 152. Each port record 152 contains the following fields: a port ID identifying the port associated with the port record; a device/router ID, which since device and router numbers are mutually exclusive, indicates whether the port connects the bridge to a device or a router, and identifies the particular device or router to which it is connected; and a field containing those spanning tree variables which are associated with each particular port.

The router list 160, shown in FIG. 11, contains a separate router record 162 for each logical router in the current configuration. Each such record contains the following fields: a router ID 164 which identifies the logical router associated with the record; a protocol list pointer 166 which points to a list of protocol records 170; and an interface list pointer which points to a list of interface records 178. The protocol list identifies all the protocols currently active for the router and contains information which the entire router uses when using that protocol.

Each protocol record 170 in the list of protocol records pointed to by the pointer 166 includes the following fields: a protocol ID 172 which identifies the protocol the record describes; a routing table 174, which, according to the known rules of the particular protocol, indicates to which interface of the router a packet having a given Network layer destination address should be routed; and table 176 which maps logical, or network layer, addresses into MAC layer addresses. The routing table 174 and the logical to MAC address table are both created as the network runs according to the known rules of the protocol specified by the protocol ID 172. For this reason, the values of these fields are not stored in NOVRAM.

Each interface record 178 in the list of interface records pointed to by the pointer 168 includes the following fields: an interface ID 180, which identifies which interface the record describes; a MAC address 182, which contains the MAC address, if any, associated with the interface; a bridge/device ID 184, which identifies if the interface is connected to a bridge or a device, and identifies the which particular device or bridge it is connected to; and an interface protocol list pointer 186, which points to a list of interface protocol records 190. Since the MAC address 182 is assigned to the interface upon initialization, it is not stored in NOVRAM.

Each interface protocol record 190 in the list of such records pointed to by the interface protocol list pointer 186 contains information for its associated interface which is specific to each protocol which has been selected for the router of which the interface is part. Each interface protocol record includes a Network layer address 192, an address mask 194, and other protocol specific information 196 such as routing metrics which tune the operation of the router.

Referring now to FIG. 8, the configuration routine 70 is comprised of loop 72 which repeats all the other steps in the routine until the user selects to exit the routine. The first step performed on every repeat of the loop 72 is step 74. This provides the user with the main configuration menu, a screen which allows the user to select from among several configuration menus or to select to leave the configuration program.

Once the user makes such a selection, the routine performs one of the following steps 76, 78, 80, or 84 which correspond to the selection.

If the user selects the Device/Bridge/Router mapping menu, the test at the top of step 76 will be met, and thus the remainder of that step will be performed. This step includes two sub-steps, 86 and 88. The first projects a menu which shows the user both the current connection between I/O devices D1-D16, logical bridges 48, and logical routers 52, and the connections that will be made between such entities once the system is re-initialized. Preferably this is done by presenting a screen which lists all I/O devices, logical bridges, and logical routers in order of their respective IDs. For each I/O device listed in order, it lists the bridge or router to which it is currently connected, if any, and to which it will be connected after re-initialization, if any. For each logical bridge listed in order, it lists the device or logical router to which it is currently connected, if any, and to which it will be connected after re-initialization, if any. Similarly, for each logical router listed in order, it lists the device or logical bridge to which it is currently connected, if any, and to which it will be connected after re-initialization, if any. The menu also allows the user to disconnect or change the connections of each device, bridge, or router and to exit the menu when done.

When the user exits the device/bridge/router mapping menu, step 88 saves the menu's information representing the mapping desired after re-initialization in NOVRAM. For each device, and then for each bridge, to be connected to a router, it stores an interface record 178 in the NOVRAM interface list associated with the router's router record 162. It gives each such successive interface record a successively numbered interface ID 180, and a bridge/device ID 184 equal to that of the connected device or bridge. Then for each device, it creates a device record 122 in NOVRAM and gives the record the device's ID, and sets its associated bridge ID 132 or associated router ID 134 to the ID of the bridge or router, respectively, to which it is connected. Then for each bridge, it creates a bridge record 142 having the bridge ID of that bridge, and having a separate port record 152 for each device or router to which the bridge is connected. Each such port record created for the bridge contains a successive port ID and a device/router ID set equal to the ID of the device or router to which the port is connected. Once this is done, all the post initialization configuration information contained in the device/bridge/router menu will have been saved in NOVRAM, and the configuration routine will return to step 74, which projects the main configuration menu.

If, from the main configuration menu of step 74, the user selects to see or change the bridge spanning tree menu, the condition at the start of step 78 will be met, causing the routine to enter the repeat loop 90. This loop repeats substeps 92, 94, and 96. Step 92 allows the user to select either which logical bridge he wishes to see by typing the ID of that bridge, or to exit to the main configuration menu of step 74. If the user selects to see a specific logical bridge, the condition of step 94 is met, and substeps 98 and 99 are performed. Step 98 projects a screen which shows the ID of the selected logical bridge, a list of its ports, which I/O device or logical bridge is connected to each such port, and, for each port connected to an I/O device, the spanning tree variables selected for that port. It also shows those spanning tree variables which relate to the bridge as a whole. The screen allows the user to change the spanning tree variables associated with each device port and with the bridge, and it allows the user to exit from the screen.

Spanning tree variables tune the spanning tree algorithm, which prevents the existence of loops in network of LANS connected by the given bridge by disabling ports, if necessary. Such variables are well known in network bridging, having been defined for each of several different bridging protocols.

When the user selects to exit the spanning tree variable screen for a given bridge, the routine enters step 99. Step 99 stores the spanning tree variables shown for each bridge in the spanning tree variable field 146 of the bridge record for that bridge. It stores the spanning tree variables for each port of that bridge in the field 156 of that bridge's corresponding port record 152. These variables are stored in both the RAM and NOVRAM Bridge list. Changing the spanning tree variables of a bridge in RAM while the system is working may alter the spanning tree configuration of the network, but it should not cause any problems.

Once step 99 is complete, the routine repeats the spanning tree selection loop by returning to step 92. This enables the user to either select another bridge or to exit the spanning tree selection process. When the user selects to exit the spanning tree variable selection, the test of step 96 is met, and the routine returns to the main configuration menu in step 74.

If the user selects the protocol selection menu from the main configuration menu, the test of step 80 is met and steps 100, 102, 104, and 106 will be performed. Step 100 lets the user select a particular logical router by specifying its ID. Once this is done, step 102 presents a screen which shows the user the ID of the selected router, which device or bridge each of its interfaces is connected to, which of the network layer routing protocols are available for the router, and which of those protocols have been selected. Once this screen is shown, the user can turn on or off each of the possible routing protocols available for the logical router, or chose to quit the screen. If the user selects a given protocol, step 104 projects a screen showing the variables associated with each interface of the given logical router for the selected protocol. These include the network layer address associated with the interface for that protocol, the address mask for the interface if appropriate for the protocol, and various other variables associated with individual router interfaces in the given protocol, such as a routing metric. Once the user selects to leave this screen, or if the user selects to exit the screen shown by step 102, step 106 alters, adds or subtracts protocol records 170 from the router's protocol list, and adds or subtracts interface protocol records 190 for each interface of the router to reflect any changes made by the user to the protocol setting for the router and for each of its interfaces. This is done both in RAM and NOVRAM, since changes in such parameters can be made while the system is operating. Once these changes have been made to memory, the configuration routine returns to the main configuration menu of step 74, allowing the user to either select another menu, or select to exit the configuration routine, through step 84.

It should be appreciated that in the preferred embodiment, the configuration routine includes other menus than those described above. These other menus relate to variables which are not as directly related to the invention as those explained above. These include menus which can establish and control filtering performed at both the bridging and routing level, and to set other parameters commonly used in routing and bridging.

As stated above, the preferred embodiment of the invention communicates with the user through an RS232 terminal, and thus a textual menu system is an appropriate way for it to allow the user to enter configuration information. It should also be understood that in other embodiments of the invention, other methods of deriving information about the desired configuration can be used. For example, the configuration could be contained in a text file that the user could edit with a text editor. It could be contained in defined locations in the system's memory which the user could peek and poke to view and change, respectively. Configuration variables could be changed with command line commands. Or, in more elaborate systems, a graphic user interface could be provided to make the connection of devices, bridges, and routers more visually intuitive.

Once the configuration mentioned above has been entered into NOVRAM, the system can be re-initialized. This is done by either turning the system off and then on, or by resetting it. In either case, the re-initialization routine 200 of FIG. 12 will be performed. The first step of this routine, step 202, tests to see there are proper device, bridge, and router lists in NOVRAM. If there are such proper lists, the step copies these lists, with all of their associated records, into RAM. In doing so, the routine expands the lists to include records or fields not stored in NOVRAM. This includes, for example, creating empty input routine pointer, output routine pointer, and MAC address assigned flag fields 126, 128, and 134, respectively, for each device record 122 copied, an empty bridge forwarding table 148 for each bridge record 142 copied, and creating an empty routing table 174 and an empty logical to MAC address table 176 for each protocol record 170 copied.

Unless there are electronic problems, there normally always should be such proper lists, unless the user has never run the configuration routine for the particular system. If this is the case, step 204 will create default device, bridge, and router lists which will give the system a default configuration. In the preferred embodiment, the default configuration is as shown FIG. 2, in which all I/O devices are configured into one logical bridge and there are no logical routers.

Once the device, bridge, and router lists, 120, 140, and 160 have been created in RAM, the initialization routine advances to step 206. For each device in the device list, this step obtains pointers to its input and output routines and places them in the fields 126 and 128 shown in FIG. 9. Once this is done, the program advances to step 208. This step seeks to assign a MAC address to each port of each bridge which is connected to a logical router. To be specific, steps 208, 210, and 212 perform the following for each port of each bridge which is connected to a router: step 214 seeks the lowest MAC address assigned to an I/O device which is connected to the bridge, the MAC address assigned flag 134 of which has not previously been assigned to a port connected to a router. The MAC address associated with each I/O device connected to a bridge can be obtained from the device itself. If such an unassigned MAC address is found, the test of step 216 is met and steps 220, 222 and 224 are performed. Step 220 places the unassigned MAC address in the MAC address field 182 of the interface record of the interface which is connected to the port. Step 222 associates the unassigned MAC address with the port in the bridge's forwarding table 148. Finally, step 224 sets the MAC address assigned flag 134 in the device record of the device from which the address was taken, indicating that the address has now been assigned to a router. If step 214 cannot find an unassigned MAC address for the port, step 218 notifies the user that an illegal configuration has been attempted, one which gives a bridge more ports connected to routers than ports connected to I/O devices.

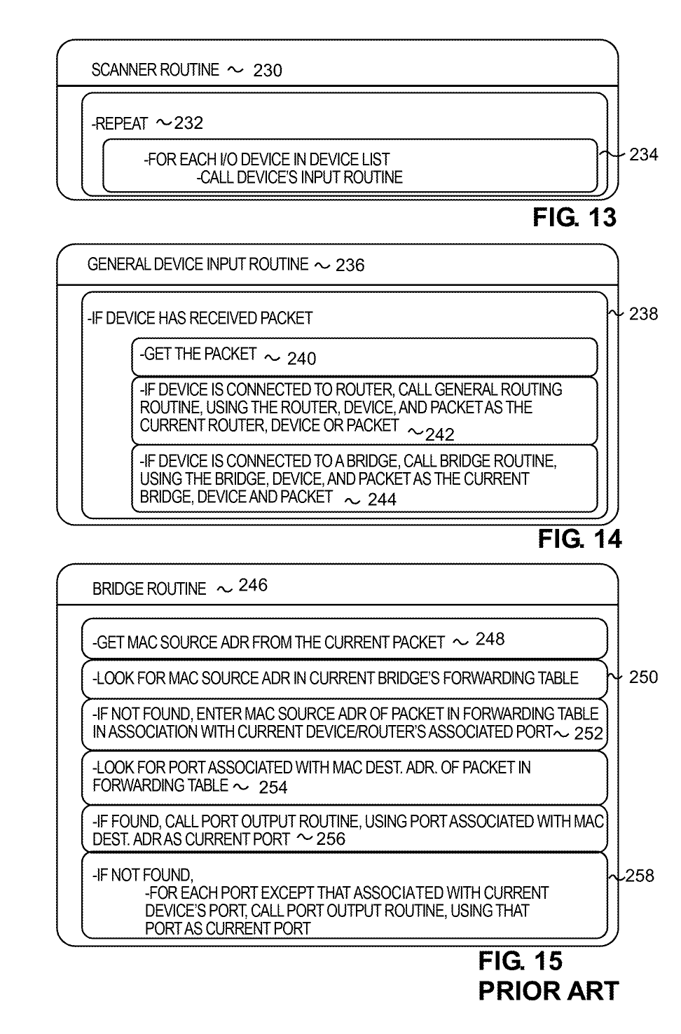

Once step 208 is completed for each port of each bridge, the initialization routine 200 is exited and the system begins the normal operation outlined in the routines of FIGS. 13-19.

FIG. 13 is the scanner routine 230. This routine is comprised of a repeat loop 232 which is repeated continuously during the normal operation of the system. This loop repeatedly cycles through each I/O device in the device list 120 in step 234 and calls the input routine pointed to by the input routine pointer 128 for that device.

As shown in FIG. 14, the input routine associated with each I/O test 238 tests to see if its associated device has received a message packet. If so, step 240 gets the packet. If the device's associated router ID contains a valid router ID, step 242 calls the router routine of FIG. 17, using the router identified, the device, and the packet as the current router, device, and packet, for purposes of the call. If, instead, the device is connected to a bridge, as is indicated by a valid associated bridge ID, step 244 calls the bridge routing of FIG. 15, using the identified bridge, the device, and the packet as the current bridge, device, and packet for purposes of that call.

If no packet has been received by the device when step 238 is performed, or if the device has no valid router or bridge ID, the routine is exited and the program flow returns to the scanner loop of FIG. 13. Similarly, when a call to either the router or bridge routine from steps 242 or 244 is complete, the program flow returns to that same loop.

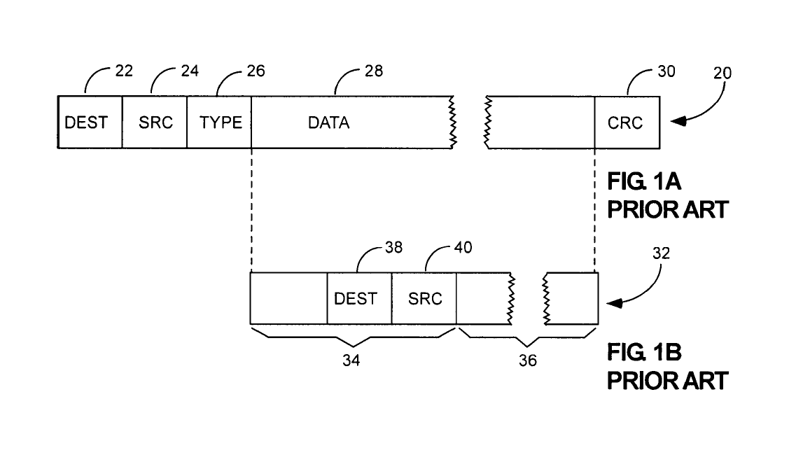

As just stated, if a device connected to a bridge receives a packet, step 244 calls the bridge routine 246 of FIG. 15. The first step of this routine, step 248, gets the MAC source address of the current packet. Since the device from which this packet was received is connected to a MAC bridge, all packets received from it should be MAC packets having a MAC address. In the preferred embodiment, the MAC bridges use the Ethernet 2.0 protocol, and the packets they receive have the form shown in FIG. 1A. Next, step 250 looks for the MAC source address in the forwarding table 148 in the current bridge's bridge record 142. If the source address is not found in the table, step 252 adds that address to the table in association with the port of the bridge to which the current device/router from which the bridge routine was called is connected. In either case, the routine advances to step 254 which obtains the MAC source address from the current packet and looks for it in the bridge's forwarding table. If the MAC destination address is found in the table, step 256 calls the port output routine using the port associated with that destination address in the table as the current port. If not, step 258 calls the port output routine for each port other than the port associated with the current device, and for each such call it uses the port for which it is made as the current port.

As is indicated in FIG. 15, the bridge routine 246 is a standard bridging routine. What is new is the way in which this bridge is called by, and can call, I/O devices and routers as a result of software configuration.

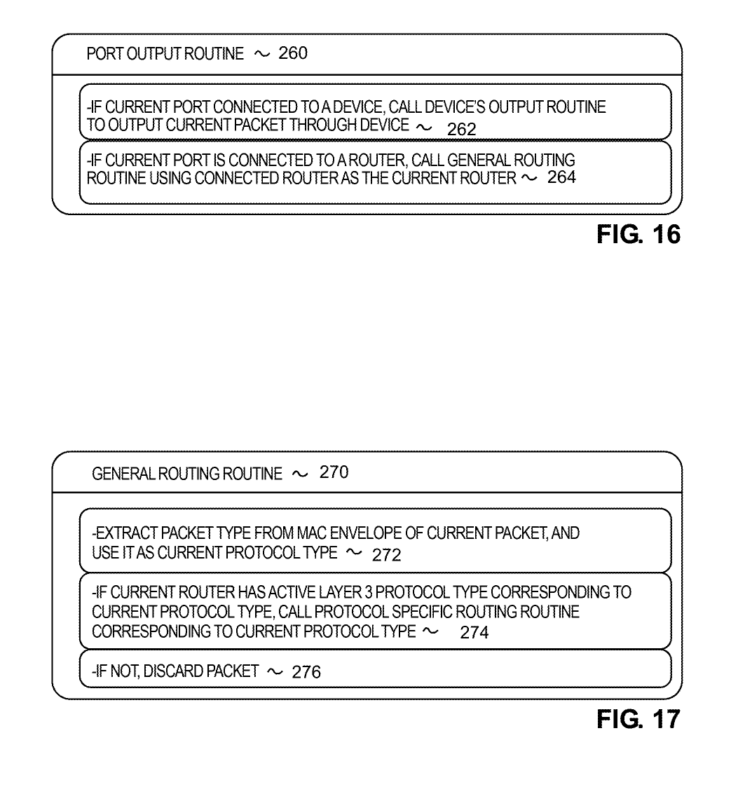

FIG. 16 shows the port output routine 260 called by the bridge routine 246. If the port for which the routine has been called is connected to an I/O device, as indicated by the device/router ID 156 of the port's port record, step 262 calls the output routine pointed to by the device's output routine pointer 128 for the current packet. If this is the case, the current device merely transmits the packet according to its standard, prior art, procedure. If the port is connected to a router, step 264 calls the general routing routine using the router to which the port is connected as the current router.

FIG. 17 shows the general routing routine 270 which can be called by step 264 of the port output routine. It can also be called by step 242 of the general device input routine 236 described above. In step 272, the general routing routine extracts the packet type from the MAC envelope of the current packet, and uses it as the current protocol type. As indicated in FIG. 1A, the Ethernet 2.0 protocol contains a field specified as the type field which contains such information. In other MAC protocols, the type of information may be contained in fields with other names, but it serves generally the same function. Once step 272 has gotten the current packet's type, step 274 determines if the current router has an associated protocol record containing a protocol ID corresponding to Network protocol capable of routing a message of the type indicated by step 272. If so, it calls the protocol specific routing routine associated with that protocol ID. If not, step 276 discards the packet.

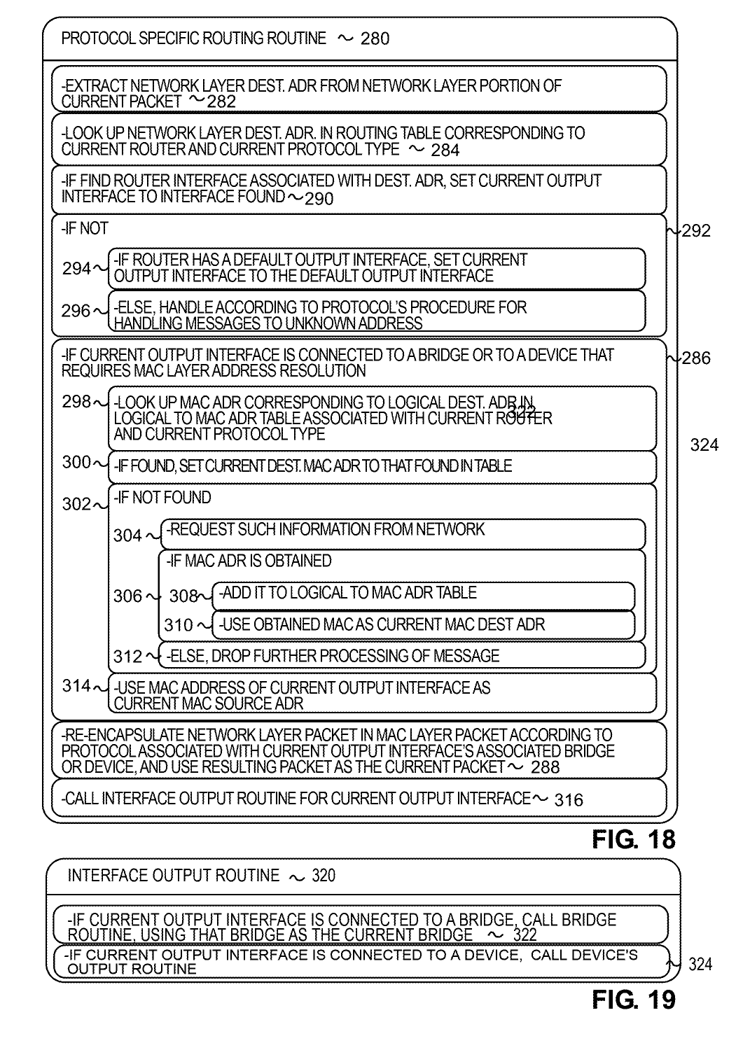

FIG. 18 gives a general description of a Network layer protocol specific routing routine 280. Step 282 of this routine extracts the Network layer destination address from the Network layer portion of the current packet. As is indicated by FIG. 1 B, most Network layer packets contain a header which includes, among other things, a source address 38 and a destination address 40. If such packets are to be sent over MAC communication channels, they must be encapsulated in MAC layer packets, as the data portion of such a MAC layer packet. This is indicated by the dotted lines between the Network layer packet of FIG. 1B and the data portion of the MAC layer packet of FIG. 1A.

Once step 282 has extracted the Network layer destination address, step 284 looks that address up in the routing table 174 of the protocol record 170 associated with the current logical router for the protocol corresponding to the protocol specific routing routine. If the routine table has an interface of the router associated with the destination address, step 290 sets the current output interface equal to that interface. If not, step 292 tests to see if the router has a default output interface which is to be used for the current protocol. If so, step 294 sets the current output interface equal to that default output interface. If not, step 296 handles the message according to the protocol's procedure for handling messages to unknown addresses. Once the current output interface has been selected for the network layer packet, step 286 looks in the bridge/device ID 184 of that interface to see if it is connected to a bridge or a device that requires that the Network layer packet be re-encapsulated as the data field of a MAC protocol packet. If the interface is connected to a bridge, the routine knows such encapsulation is required. If the interface is connected to a device, the step queries the device to determine whether or not encapsulation is necessary. If such encapsulation is required, step 298 looks up the MAC address corresponding to the Network layer destination address in the logical to MAC address table 176 for the current protocol record 170 of the current router. If the corresponding MAC address is found, step 300 sets the current MAC destination address equal to it. If not, step 302 is performed. This step requests the MAC address corresponding to Network layer destination address using a method for doing so associated with the current protocol. For example, if the IP protocol is being used, then a procedure known as Address Resolution Protocol, or ARP, will be used. This protocol sends a request for the MAC address corresponding to a given Network address through the network. If a device which uses the protocol and which knows the MAC address receives such a message, it will sent it back through the network to the requesting device. If the request in step 304 obtains the desired MAC address, step 306 which cause step 308 to add the MAC address to the logical to MAC address table 176 so that it can be used if a similarly-addressed message is processed in the near future, and step 310 sets the MAC address obtained as the current MAC destination address. If the MAC address corresponding to the Network layer destination address is not obtained, step 312 drops further processing of the message because it cannot be sent any further.

Assuming that the MAC address corresponding to the Network layer destination address is obtained one way or the other, step 314 sets the current MAC source address equal to the MAC address of the current output interface. Then step 288 re-encapsulates the Network layer packet in a MAC layer packet, if any, required by the protocol used by the bridge or I/O device connected to the current output interface. If the current output interface is connected to a bridge or an I/O device which uses a MAC layer protocol, the Network packet will be encapsulated in a MAC packet which uses the current MAC source address of the interface, as set in step 314, and the current MAC destination address as set in step 300 or 310. If the interface is connected to an I/O device which does not require MAC level encapsulation, no encapsulation will be performed. Once step 288 is complete, the packet is ready to be output by the protocol specific routing routine, and thus step 316 calls the interface routine for the current output interface.

FIG. 19 shows the interface output routine 320 which is called by step 316 of FIG. 18. If the current output interface is connected to a bridge, as is indicated by the bridge/device ID 184 of the interface's interface record, then the bridge routine 246 of FIG. 15 is called, using the bridge indicated by that ID as the current bridge, the current router as the bridge routine's current device/router, and the packet output by the protocol specific routing routine as the current packet. If the interface is connected to an I/O device, the devices output routine for that packet is called.

The above described combination of data structures and routines is capable of causing packets to be properly switched between any of the devices shown in the configurations shown in FIGS. 2-7. This can be seen by tracing a proper packet between any two such devices, taking into account these data structures and routines.

For example, the progress of a MAC packet sent between any two devices connected directly to the ports of the same logical bridge can be traced as follows. When the packet is received at one device, a subsequent call by the scanner routine 230 is made to the input routine 236 for that device, and step 244 of that routine will call the bridge routine for the bridge connecting the two devices. The bridge routine 246 will use traditional MAC bridging based on the MAC destination address of the packet, to call the port output routine 260 associated with the device through which the output is to be transmitted. This routine will in turn call the output routine associated with the device through which the packet is to be output, causing it to be transmitted as desired.

A more complex example would be a packet sent between two I/O devices which are connected to separate bridges that are connected by a router. The MAC packet includes as its data portion a proper Network layer packet of a protocol corresponding to the MAC layer's type information. Referring to FIG. 6, a packet is set from a host H11, connected through I/O device D1 to Bridge 1, to a Host H52, connected through I/O device D5 to Bridge 3. Host H11 has the Network layer address of H52. By the known Network layer procedure for obtaining the MAC address associated with a desired Network level address discussed above with regard to step 304 of FIG. 18, H11 learns that if it wants to send a message to H52 over the MAC level communications channel to which it is connected, it must send using as the MAC destination address the MAC address associated by Bridge 1 with its port P4, the port connected to router 1. It also knows that it must include inside the MAC packet a Network layer packet containing as the Network layer destination address the address of H52.

When H11 sends the MAC packet, it is received by I/O device D1. When the scanner routine 230 calls D1's input routine, that routine will call the bridging routine 246 for Bridge 1. Seeing that the packet's MAC address is to the address associated by its forwarding table with port P4, the bridging routine will call the port output routine 260 for that port, which in turn will call the general routing routine for router 1. Since it is presumed that the MAC packet contains the appropriate type information for the protocol of its encapsulated Network layer packet, the general routing routine will call the appropriate protocol specific routing routine 280 corresponding to the packet. This routine will then route the Network layer packet to the protocol specified, as described generally in FIG. 18. This routing protocol will cause the Network layer packet to be re-encapsulated in a MAC packet having the MAC address of H52, and will cause the interface 15 which is connected to Bridge 3 to be the current output interface. It will then call the interface output routine 320.

Since interface 15 is connected to Bridge 3, the output interface routine will call the bridging routine 246 for the newly encapsulated packet. Since this packet contains the MAC address of H52, the bridging routing will cause the output routine of I/O device D5, which is connected to H52, to be called for the packet. This will cause the packet to be transmitted on the LAN link connecting I/O device D5 to H52, allowing host H52 to receive the message.

It should be understood that the foregoing description and the drawings are given merely to explain and illustrate the invention, and the invention is not be limited thereto, except insofar as the interpretation of the appended claims are so limited. Those skilled in the art who have the disclosure before them will be able to make modifications and variations therein without departing from the scope of the invention.

For example, other data structures, such as arrays instead of lists, could be used instead of those described above without departing from the invention. Similarly, those skilled in the art will understand that the data used to configure the bridge/router of the present invention could be easily organized in many different ways and still accomplish the same basic results.

Those skilled in the art will understand that many common computing techniques could be used to alter the routines described above without altering the basic features of the invention. For example, devices could use interrupt when they receive data to invoke their input routines rather than always relying on the scanner to call such routines. This would be particularly beneficial for I/O devices which receive data at a sufficiently slow rate that it is inefficient to have a scanner routing constantly call their input routine. It should also be obvious that the order of function and the group of functions into routines could be varied without significantly changing the invention.

Those skilled in the computing arts will understand that the present invention could be used in a computer using multiple processors without changing its basic import. For example, as the cost of processing power drops it would be possible to have separate processors allocated for different groups of one or more logical bridges or routers.

It should also be understood that the invention can be used with any MAC layer protocol which uses bridges, and any Network layer protocol which uses routers.

Although not shown, it should further be understood that according to the above described scheme one bridge can be connect to two separate routers. It should also be understood that the present invention is meant to cover the connection of a logical bridge to other logical bridges and of a logical router to other logical routers. Allowing bridges to be connected to bridges would require little more than allowing the device/router ID 156 of port records to contain Bridge ID, and modifying the port output routine 260 to call a bridge routine for a given bridge if it found that the device/bridge/router ID corresponded to that bridge. Similarly, allowing routers to be connected to other routers would require little more than allowing the bridge/device ID 184 of interface records to contain router IDs, and modifying the interface output routine 320 to call the general router routine for a given router if the bridge/router/device ID for that interface was identified with that router.

1. A network switching device comprising:
a plurality of input/output devices configured to communicate packets;
an enabler configured to enable a user to selectively associate each of said input/output devices with a selected one or more of a plurality of logical bridges, and to create one or more data structures that represent which input/output devices have been associated with each logical bridge by the user; and
a responder configured to respond to said one or more data structures by causing each logical bridge with which one or more input/output devices have been associated to operate as a media access control level bridge including, and having an attached port for, each of the input/output devices represented as associated with such logical bridge by said one or more data structures.

2. A network switching device, comprising:
a plurality of input/output devices, each configured to communicate packets;
a processing unit and a memory, the processing unit configured to associate each of the input/output devices with at least one logical switching device, wherein each logical switching device includes one of a logical bridge and a logical router; and
at least one data structure stored in the memory and configured to contain configuration information of the at least one logical switching device.

3. The network switching device of claim 2, wherein the at least one logical switching device comprises one of:
a logical bridge;
a logical router;
a plurality of logical bridges;
a plurality of logical routers;
a logical bridge and a logical router;
a logical router and a plurality of logical bridges;
a plurality of logical routers and a logical bridge; and
a plurality of logical routers and a plurality of logical bridges.

4. The network switching device of claim 1, further comprising a user interface which is one of a text user interface and a graphic user interface.

5. The network switching device of claim 2, wherein the at least one data structure comprises:
an input/output device list containing a separate input/output device record associated with each input/output device;
a bridge list containing a separate bridge record for each logical bridge; and
a router list containing a separate router record for each logical router.

6. A network switching device comprising:
a plurality of input/output devices configured to communicate packets;
an enabler configured to enable a user to selectively associate each of said input/output devices with a selected one or more of a plurality of logical bridges, and to create one or more data structures that represent the input/output devices which have been associated with each logical bridge by the user; and
a responder configured to respond to said one or more data structures by causing each logical bridge with which one or more input/output devices have been associated to operate as a media access control level bridge including each of the input/output devices represented as associated with such logical bridge by said one or more data structures, wherein the enabler is further configured to enable a user to selectively associate each of said logical bridges with a selected one or more of a plurality of logical routers, and to create one or more data structures that represent which logical bridges have been associated with each logical router by the user; and
wherein the responder is further configured to respond to said one or more data structures representing which logical bridges have been associated with each logical router by causing each logical router to operate as a separate logical router having an interface to each of the logical bridges.

7. A network switching device comprising:
a plurality of input/output devices configured to communicate packets;
an enabler configured to enable a user to selectively associate each of said input/output devices with a selected one or more logical bridges, and to create one or more data structures that represent the input/output devices which have been associated with each logical bridge by the user; and
a responder configured to respond to said one or more data structures by causing each logical bridge with which one or more input/output devices have been associated to operate as a media access control level bridge including, and having an attached port for, each of the input/output devices represented as associated with such logical bridge by said one or more data structures,
wherein the enabler is further configured to enable a user to selectively associate each of said logical bridges with a selected one or more logical routers, and to create one or more data structures that represent which logical bridges have been associated with each logical router by the user; and
wherein the responder is further configured to respond to said one or more data structures representing which logical bridges have been associated with each logical router by causing each logical router with which one or more logical bridges has been associated to operate as a separate network layer router having a network interface to each of the bridges represented as associated with such logical router by said one or more data structures.

8. A network switching device comprising:
a plurality of input/output devices configured to communicate packets;
an enabler configured to enable a user to selectively associate a plurality of logical bridges with a selected internal connection among logical bridges, and to create one or more data structures that represent the logical bridges which have been associated with the selected internal connection among logical bridges; and
a responder configured to respond to said one or more data structures representing which logical bridges have been associated with the selected internal connection among logical bridges by causing the selected internal connection among logical bridges to operate as a separate internal connection to which each of its logical bridges is represented as associated by one or more data structures by forwarding packets from one associated logical bridge to all other associated logical bridges.

9. A network switching device comprising:
a plurality of input/output devices configured to communicate packets;
an enabler configured to enable a user to selectively associate a plurality of logical routers with a selected internal connection among logical routers, and to create one or more data structures that represent the logical routers which have been associated with the selected internal connection among logical routers; and
a responder configured to respond to said one or more data structures representing which logical routers have been associated with the selected internal connection among logical routers by causing the selected internal connection among logical routers to operate as a separate internal connection to which each of its logical routers is represented as associated by one or more data structures by forwarding packets from one associated logical router to all other associated logical routers.

10. A network switching device comprising:
a plurality of input/output devices configured to communicate packets;
an enabler configured to enable a user to selectively associate a plurality of logical switching devices, each of which may be either a logical router or a logical bridge, with a selected internal connection among logical switching devices, and to create one or more data structures that represent the logical switching devices which have been associated with the selected internal connection among logical switching devices; and
a responder configured to respond to said one or more data structures representing which logical switching devices have been associated with the selected internal connection among logical switching devices by the selected internal connection among logical switching devices to operate as a separate internal connection to which each of its logical switching devices is represented as associated by one or more data structures by forwarding packets from one associated logical switching devices to all other associated logical switching devices.
